(19) United States
(12) Patent Application Publication
(10) Pub. No.: US 2011/0155262 A1
(43) Pub. Date: Jun. 30, 2011

(54) Level Sensor and System Comprising a Level Sensor and A Fluid Reservoir

(75) Inventors: Johannes Ante, Regensburg (DE); Manfred Weigl, Viehhausen (DE)

(73) Assignee: Continental Automotive GmbH, Hannover (DE)

(21) Appl. No.: 13/002,458

(22) PCT Filed: Jul. 3, 2009
(86) PCT No.: PCT/EP2009/058374

§ 371 Date: Jan. 28, 2011

(30) Foreign Application Priority Data
Jul. 4, 2008 (DE) 10 2008 031 647.4

(51) Int. Cl. F16K 49/00; G01F 23/26

(52) U.S. Cl. 137/341; 73/304 C

(57) ABSTRACT

A level sensor includes a base unit with a cavity. A first axial end of the cavity is adapted to hydraulically communicate with a fluid reservoir. A second axial end of the cavity is adapted to hydraulically couple to a fluid reservoir. A heating element is disposed in a wall of the cavity. A first electrode and a second electrode are disposed at the base unit such that an electric capacitance formed between the first electrode and the second electrode is representative of the level in the fluid reservoir.

### PRIORITY CLAIM

This is a U.S. national stage of Application No. PCT/EP2009/058374, filed on Jul. 3, 2009, which claims priority to German Application No: 10 2008 031 647.4, filed: Jul. 4, 2008, the contents of which are incorporated herein by reference.

### BACKGROUND OF THE INVENTION

1. Field of the Invention

The invention relates to a level sensor and a system comprising a level sensor and a fluid reservoir.

2. Related Art

To comply with legal restrictions on pollutant emissions when operating internal combustion engines, exhaust gas that is formed can be aftertreated. In particular, efforts are made to make nitrogen oxides contained in the exhaust gas react to give harmless substances. This kind of pollutant reduction is employed with diesel internal combustion engines and is carried out in a special exhaust gas catalytic converter. The exhaust gas catalytic converter is preferably an SCR catalytic converter in an SCR system. In this context, SCR means “selective catalytic reduction”.

Nitrogen oxides contained in the exhaust gas of an internal combustion engine can be decomposed by ammonia, which can be obtained from a special ammonia medium while the internal combustion engine is being operated. The special ammonia medium can be an aqueous urea solution. For exhaust gas aftertreatment, the aqueous urea solution is pumped out of a fluid reservoir by a fluid pump and into a urea injection valve, which meters the urea solution for the SCR catalytic converter into the exhaust gas stream from the internal combustion engine. The urea solution held ready in the fluid reservoir has basic properties and has a freezing temperature of −11° C.

Accurate determination of the level of urea solution in the fluid reservoir is a prerequisite for effective reduction of pollutant emissions from internal combustion engines by decomposition of nitrogen oxides.

A capacitive level sensor for fuel tanks is known from DE 10 2006 050 661 A1. An external electrode is constructed in the form of a hollow profile of flat cross section, and an internal electrode is formed from a flat strip of material, which is surrounded on all sides, by way of spacing, by a supporting structure that allows the entry of a fluid, allowing the flat strip of material of the internal electrode together with the flat hollow profile of the external electrode to be bent around one or more of the principal axes of the cross section of the hollow profile without the electrodes touching each other as a result of the bending of the electrode arrangement.

### SUMMARY OF THE INVENTION

It is an underlying object of the invention to provide a level sensor and a system comprising a level sensor and a fluid reservoir that allows reliable and reproducible determination of the level of a fluid in the fluid reservoir.

According to a first embodiment of the invention a level sensor comprising a base unit has a cavity. A first axial end of the cavity is designed to hydraulically communicate with a fluid reservoir. A second axial end of the cavity is designed to hydraulically couple to a fluid store. A heating element is disposed in the wall of the cavity. A first electrode and a second electrode are disposed on the base unit in such a way that a capacitance formed between the first electrode and the second electrode that is representative of the level in the fluid reservoir. This enables reliable and accurate determination of the level of a fluid in the fluid reservoir by virtue of the fact that, particularly in the case of low outside temperatures below the melting point of the fluid, occurrence of the fluid in the liquid phase can be ensured by the heating element.

In an advantageous embodiment, the first electrode and the second electrode are each designed in such a way that they extend from a region of the first axial end of the cavity to a region of the second axial end of the cavity. This allows the construction of a reliable level sensor by virtue of the fact that a change in the level entails a change in the capacitance which is sufficiently large for determination.

According to one embodiment, the first electrode and the second electrode are designed to be electrically isolated from each other and are disposed in such a way that they each form a hollow half-cylinder and are disposed together in the form of a hollow cylinder in the wall. This allows the level sensor to be designed with a high sensitivity by virtue of the fact that the capacitance formed between the first electrode and the second electrode is decisively influenced by the level.

In one embodiment, the first electrode and the second electrode are surrounded by an outer shell of the wall. This allows the level sensor to be designed with a high sensitivity by virtue of the fact that the capacitance formed between the first electrode and the second electrode is decisively influenced by the fluid level.

According to another advantageous embodiment, the outer shell of the wall comprises polyoxymethylene. This allows the construction of a level sensor which is corrosion-resistant to chemically aggressive fluid.

According to one embodiment of the invention a level sensor comprising a base unit has a cavity. A first axial end of the cavity is designed to hydraulically communicate with a fluid reservoir. A second axial end of the cavity is designed to hydraulically couple to a fluid store. A heating element is disposed in a wall of the cavity. A first electrode is disposed on the base unit and a second electrode is disposed outside the base unit in a region of the fluid reservoir such that a capacitance formed electrically between the first electrode and the second electrode is representative of the level in the fluid reservoir. This allows reliable determination of the level, even when the fluid reservoir is tilted.

In an one embodiment, the first electrode is designed in such a way that it extends from a region of the first axial end of the cavity to a region of the second axial end of the cavity. This allows the construction of a reliable level sensor by virtue of a sufficiently large change in the capacitance in the event of a change in the level and an associated high sensitivity of the level sensor.

According to one embodiment, the first electrode is in the form of a hollow cylinder in the wail of the cavity. This allows the level sensor to be designed with a high sensitivity by virtue of the fact that the capacitance formed between the first electrode and the second electrode is decisively influenced by the level.

In one embodiment, the first electrode is surrounded by an outer shell of the wall. This allows the level sensor to be designed with a high sensitivity by virtue of the fact that the capacitance formed between the first electrode and the second electrode is decisively influenced by the level.

According to one embodiment, the outer shell of the wall comprises polyoxymethylene. This allows the construction of a level sensor which is corrosion-resistant to chemically aggressive fluids.

In one embodiment, the second electrode is disposed on a reservoir wall of the fluid reservoir. This allows reliable determination of the level, even when the fluid reservoir is tilted.

According to one embodiment, the first electrode and the second electrode are designed in such a way as to be electrically isolated from the fluid. This is an effective way of preventing corrosion of the first electrode and of the second electrode.

In one embodiment, the heating element is in the form of a hollow cylinder in the wall. This allows the entire wall of the cavity to be heated in an effective manner.

In one embodiment, the heating element extends in the wall from a region of the first axial end of the cavity to a region of the second axial end of the cavity. This makes it possible to heat the level sensor in a particularly effective manner over the length of the cavity and hence to thaw any fluid which may have frozen.

In one embodiment, the heating element is thermally coupled to the wall. This makes it simple to ensure that the fluid in the level sensor is in the liquid phase, especially at low temperatures below the melting point of the fluid.

According to one embodiment, the base unit comprises a temperature sensor element. This can enable control of the temperature that can be set by the heating element.

According to one embodiment, the temperature sensor element is disposed in the region of the first axial end of the cavity. This makes it simple to determine the temperature of the fluid before withdrawing fluid through the cavity of the level sensor.

According to one embodiment, the invention is distinguished by a system comprising a level sensor and a fluid reservoir for storing fluid. The level sensor is disposed in the fluid reservoir.

In one embodiment, the level sensor is disposed in the fluid reservoir in such a way that the second axial end of the cavity is disposed above a maximum level with respect to the level. If the fluid in the fluid reservoir is frozen, at least at the surface, it can be thawed out in an effective manner up to the level of the fluid by the heating element, at least in the immediate vicinity of the level sensor. This makes it possible to prevent a vacuum in the fluid reservoir, which can occur if fluid is withdrawn from the fluid reservoir when the fluid is frozen.

### BRIEF DESCRIPTION OF DRAWINGS

Illustrative embodiments of the invention are explained in greater detail below with reference to the schematic drawings, in which:

FIG. 1 is a system comprising a first embodiment of a level sensor and a fluid reservoir in a longitudinal section;

FIG. 2 is in a cross section of a level sensor; and

FIG. 3 is a system comprising a second embodiment of a level sensor and a fluid reservoir in a longitudinal section.

### DETAILED DESCRIPTION OF THE DRAWINGS

Elements of the same design or function are provided with the same reference signs in all the figures.

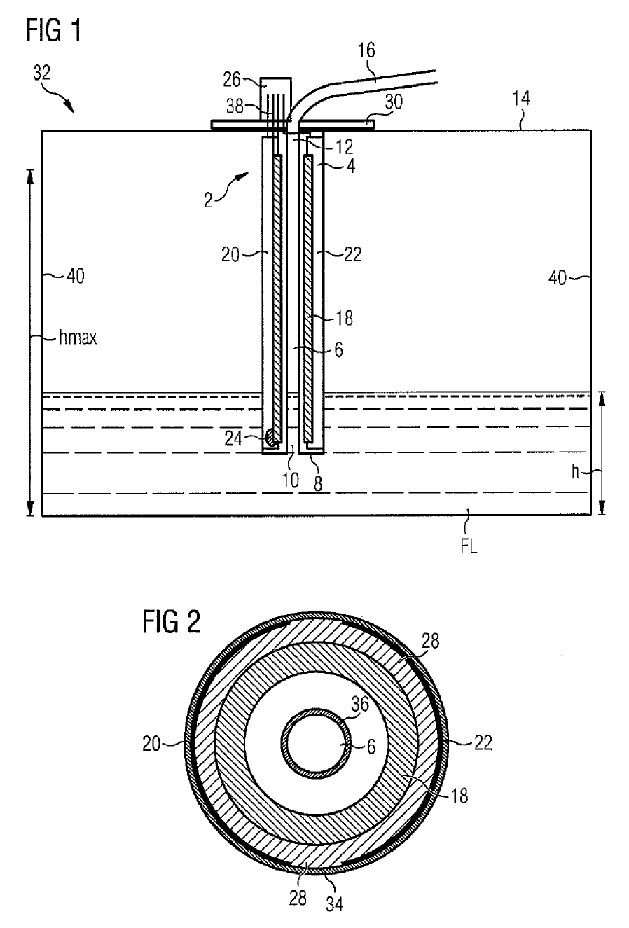

FIG. 1 is a level sensor 2 comprising a base unit 4. The base unit 4 comprises a cavity 6 comprising a wall 8. The cavity 6 has a first axial end 10 and a second axial end 12, the first axial end 10 being designed to hydraulically communicate with a fluid reservoir 14 and the second axial end 12 being designed to hydraulically couple to a fluid store 16. A heating element 18, a first electrode 20 and a second electrode 22 are formed in the wall 8. A temperature sensor element 24 is furthermore formed in the wall 8 in the region of the first axial end 10 of the cavity 6. An electrical connection 26 is formed in the region of the second axial end 12 of the cavity 6 for electrical coupling of electrical contacts 38. A flange 30 is furthermore formed in the region of the second axial end 12 of the cavity 6 to couple the level sensor 2 mechanically to the fluid reservoir 14.

The level sensor 2 is designed for capacitive level measurement of a fluid FL at a level h situated in the fluid reservoir 14. A capacitance formed electrically between the first electrode 20 and the second electrode 22 is representative of the level h in the fluid reservoir 14. To make the level sensor 2 as sensitive as possible, it is advantageous if the first electrode 20 and the second electrode 22 are each designed in such a way that they extend from a region of the first axial end 10 of the cavity 6 to a region of the second axial end 12 of the cavity 6. It is furthermore advantageous if the first electrode 20 and the second electrode 22 are designed in such a way as to be electrically isolated from each other and are disposed in such a way that they each form a hollow half-cylinder and are disposed together in the form of a hollow cylinder in the wall 8 (FIG. 2).

The level sensor 2 allows simple mechanical coupling to the fluid reservoir 14 by way of the flange 30 and simple electrical coupling of electrical contacts 38 by way of the electrical connection 26. Via the base unit 4 with the cavity 6 of the level sensor 2, the fluid reservoir 14 can communicate hydraulically with a fluid store 16 coupled to the second end 12 of the cavity 6. For example, fluid FL can be withdrawn from the fluid reservoir 14 by the level sensor 2. The cavity 6 can thus be designed as a withdrawal tube, for example. Combination of the cavity 6 as a withdrawal tube with the heating element 18 disposed in the wall 8, the first electrode 20 and the second electrode 22 for capacitive level measurement has the advantage that the number of discrete components in the fluid reservoir 14 is small. In particular, the result is a small number of penetrations and sealing locations for mechanical contacts and the electrical contacts 27, and this reduces the susceptibility of the system to faults and greatly simplifies installation of the level sensor 2 in the fluid reservoir 14. Furthermore, the level h is measured at a position in the fluid reservoir 14 which is favorable with respect of the heat output of the heating element 18. If the first electrode 20 and the second electrode 22 are disposed at the same level in the wall 8 as the heating element 18, it is a very simple matter to determine how much fluid FL can be withdrawn from the fluid reservoir 14 without exposing the heating element 18. For example, the heat output of the heating element 18 can be reduced if the level h is at a lower limit.

The fluid reservoir 14 is designed to hold the fluid FL up to a maximum level hmax. The fluid reservoir 14 can be a tank e.g. a reducing agent tank for holding a fluid FL containing ammonia in an SCR catalytic converter for the chemical decomposition of nitrogen oxides from the exhaust gas of an internal combustion engine.

The fluid FL containing ammonia can be urea, e.g. a 32.5% urea solution. Urea solution is a chemically aggressive fluid FL with basic properties. A 32.5% urea solution typically has a pH of from 9 to 9.5.

Owing to the chemical properties of urea solutions, metal components of the level sensor 2 are designed to be electrically isolated from the fluid FL in a preferred embodiment. As shown in FIG. 2, the first electrode 20 and the second electrode 22 are preferably surrounded by an outer wall 34 which is resistant to chemical corrosion. The outer wall 34 comprises polyoxymethylene, for example, also known as POM. An inner wall 36 can likewise comprise POM.

Urea solution can have a melting point of −11° C. At low outside temperatures below the melting point of the fluid FL in the fluid reservoir 14, the fluid FL may at least partially freeze in the fluid reservoir 14. For reliable determination of the level h of fluid FL in the fluid reservoir 14, the level sensor 2 can be heated by means of the heating element 18. It is advantageous if the heating element 18 is in the form of a hollow cylinder in the wall 8 and extends in the wall 8 from a region of the first axial end 10 of the cavity 6 to a region of the second axial end 12 of the cavity 6. This makes it possible to heat the level sensor 2 in a particularly effective manner over the length of the cavity 6 and hence to thaw any fluid FL which may have frozen.

In a preferred embodiment, the wall 8 of the cavity 6 is filled with a thermally conductive potting compound 28. In this way, the fluid FL can be reliably prevented from freezing, at least in a region around the level sensor 2. The temperature sensor element 24 can be used to determine a temperature, thus allowing control of the temperature set by the heating element 18.

It is advantageous if the level sensor 2 is disposed in the fluid reservoir 14 in such a way that the second axial end 12 of the cavity 6 is disposed above the maximum level hmax. In the case of a fluid FL in the fluid reservoir 14 which has frozen, at least at the surface, it can be thawed out in an effective manner up to the level h by the heating element 18, at least in the immediate vicinity of the level sensor 2. This makes it possible to prevent a vacuum in the fluid reservoir 14, which can occur if fluid FL is withdrawn from the fluid reservoir 14 when the fluid FL is frozen.

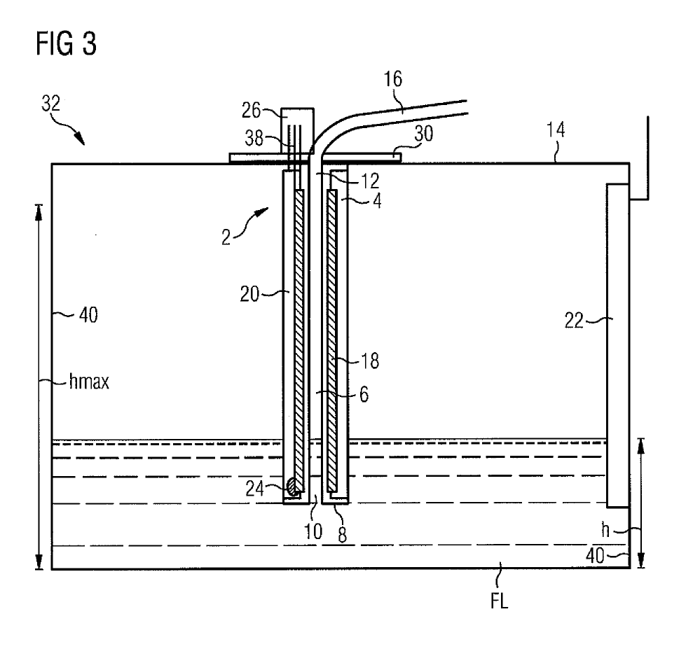

FIG. 3 shows a second embodiment of the level sensor 2 disposed in the fluid reservoir 14. The first electrode 20 is disposed in the wall 8 of the cavity 6, and the second electrode 22 is disposed on a reservoir wall 40 of the fluid reservoir 14.

The first electrode 20 is preferably in the form of a hollow cylinder and preferably extends from a region of the first axial end 10 of the cavity 6 to a region of the second axial end 12 of the cavity 6. The second electrode 22 can be in the form of a strip and is preferably disposed along the cavity 6, on the reservoir wall 40.

In a preferred embodiment, the first electrode 20 and the second electrode 22 are designed in such a way as to be electrically isolated from the fluid FL. The first electrode 20 is preferably surrounded by an outer shell 34 of the wall 8. The outer shell 34 is preferably constructed from a corrosion-resistant material and can comprise polyoxymethylene, for example. The second electrode 22 can be disposed in the reservoir wall 40, for example.

As regards the cross section, as shown in FIG. 2, for the first embodiment of the level sensor 2, the second embodiment differs from the first embodiment in that, in the second embodiment, only the first electrode 20, which is in the form of a hollow cylinder, is disposed in the wall 8 of the cavity 6.

The first embodiment and the second embodiment of the level sensor 2 can be combined in any desired way, particularly as regards their configuration.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-19. (canceled)

20. A level sensor, comprising:
a base unit having longitudinal cavity therethrough;
a first axial end of the cavity configured to hydraulically communicate with a fluid reservoir;
a second axial end of the cavity configured to hydraulically couple to a fluid store;
a heating element disposed in a wall of the base unit forming the cavity;
a first electrode disposed on the wall of the base unit; and
a second electrode disposed on the wall of the base unit such that a capacitance is formed between the first electrode and the second electrode,
wherein the capacitance is representative of a level in the fluid reservoir.

21. The level sensor as claimed in claim 20, wherein the first electrode and the second electrode extend from a region proximate to the first axial end of the cavity to a region proximate to the second axial end of the cavity.

22. The level sensor as claimed in claim 21, wherein the first electrode and the second electrode are configured to be electrically isolated from each other and arranged such that they each form a hollow half-cylinder and are disposed together in a form of a hollow cylinder.

23. The level sensor as claimed in claim 22, further comprising an outer shell of the wall configured to surrounded the first electrode and the second electrode.

24. The level sensor as claimed in claim 23, wherein the outer shell of the wall comprises polyoxymethylene.

25. A level sensor, comprising
a base unit, having a longitudinal cavity therethrough;
a first axial end of the cavity configured to hydraulically communicate with a fluid reservoir;
a second axial end of the cavity configured to hydraulically couple to a fluid store;
a heating element disposed in a wall of the cavity;
a first electrode disposed on the base unit; and
a second electrode disposed outside the base unit in a region of the fluid reservoir such that a capacitance formed between the first electrode and the second electrode is representative of a level in the fluid reservoir.

26. The level sensor as claimed in claim 25, wherein the first electrode is configured to extend from a region proximate to the first axial end of the cavity to a region proximate to the second axial end of the cavity.

27. The level sensor as claimed in claim 26, wherein the first electrode is a hollow cylinder in the wall of the cavity.

28. The level sensor as claimed in claim 27, wherein the first electrode is surrounded by an outer shell of the wall.

29. The level sensor as claimed in claim 28, wherein the outer shell of the wall comprises polyoxymethylene.

30. The level sensor as claimed in claim 25, wherein the second electrode is disposed on a reservoir wall of the fluid reservoir.

31. The level sensor as claimed claim 25, wherein the first electrode and the second electrode are electrically isolated from the fluid of the fluid reservoir.

32. The level sensor as claimed in claim 25, wherein the heating element is configured as a hollow cylinder in the wall.

33. The level sensor as claimed in claim 25, wherein the heating element extends in the wall from a region proximate to the first axial end of the cavity to a region proximate to the second axial end of the cavity.

34. The level sensor as claimed claim 33, wherein the heating element is thermally coupled to the wall.

35. The level sensor as claimed in claim 25, further comprising a temperature sensor element in the base unit.

36. The level sensor as claimed in claim 35, wherein the temperature sensor element is disposed in the region of the first axial end of the cavity.

37. A system comprising:
a fluid reservoir for storing fluid; and
a level sensor disposed in the fluid reservoir comprising:
a base unit having longitudinal cavity therethrough;
a first axial end of the cavity configured to hydraulically communicate with the fluid reservoir;
a second axial end of the cavity configured to hydraulically couple to a fluid store;
a heating element disposed in a wall of the base unit forming the cavity;
a first electrode disposed on the wall of the base unit; and
a second electrode disposed one of on the wall of the base unit and a wall of the fluid reservoir such that a capacitance is formed between the first electrode and the second electrode,
wherein the capacitance is representative of a level in the fluid reservoir.

38. The system as claimed in claim 37, wherein the level sensor is disposed in the fluid reservoir such that the second axial end of the cavity is disposed above a maximum fluid level.
